(19) United States
(12) Patent Application Publication
(10) Pub. No.: US 2002/0109604 A1
(43) Pub. Date: Aug. 15, 2002

(54) Display system for a passenger loading apparatus

(76) Inventor: Barry S. Martin, Glen Allen, VA (US)

Correspondence Address: McGuire Woods LLP, Suite 1800, 1750 Tysons Boulevard, McLean, VA, 22102, US

(21) Appl. No.: 10/052,573

(22) Filed: Jan. 23, 2002

Related U.S. Application Data
(60) Provisional application No. 60/263,188, filed on Jan. 23, 2001.

(51) Int. Cl. G08B 5/00

(52) U.S. Cl. 340/815.4; 340/540

(57) ABSTRACT

A display system and an advertisement system for a passenger loading apparatus having displays positioned on the interior surfaces of the loading apparatus is described. The displays may be stickers, panels, LCD screens, television type monitors, wall pockets or the like. The displays may take any shape and size. A plurality of displays may be used in the passenger loading apparatus that correspond to a particular theme.

### CROSS REFERENCE TO RELATED APPLICATION

The present application is based on U.S. Provisional Application No. 60/263,188, filed on Jan. 23, 2001, herein incorporated by reference in its entirety.

### FIELD OF THE INVENTION

The present invention is directed to a passenger loading apparatus having a display contained therein.

### BACKGROUND OF THE INVENTION

Signs are often used to provide messages to people. These signs take the form of various advertisements such as, for example, billboards, place cards, and the like. The dissemination of the message is partially dependent on the number of people who notice the sign. Specifically, some advertisements placed on the roadside may be directed to restaurants, amusement parks, museums or other forms of entertainment, all of which may be pertinent to a traveler. Similarly, an advertisement in a bookstore may be directed to a best selling book, a technical book or audio tapes, all designed for the more educated consumer. In essence, these advertisements are typically used to promote the product or service. Typically, however, these types of locations do not provide a captive audience for viewing the advertisement. That is, in many instances these signs are merely a nuisance or are so misplaced that a person is disinterested in even reading such advertisement.

### SUMMARY OF THE INVENTION

It is an object of the present invention to provide displays on the interior surface of a passenger loading apparatus such that they are visible to passengers passing through the loading apparatus.

The present invention includes an advertisement system adapted to be placed along a passenger loading apparatus. The advertisement system includes at least one display adapted to be displayed on at least one interior surface of the passenger loading apparatus such that the display is in plain view of a passenger passing therethrough. The display may be selected from the group consisting of a panel, sticker, LCD screen, a television monitor, wall pocket, and combinations thereof. Further, the advertising system may include a plurality of displays. Still further, the present invention includes at least one display on at least two surfaces of the passenger loading apparatus. The at least two surfaces may include a ceiling and wall and the at least one display may covers at least a portion of the ceiling and wall of the passenger loading apparatus. A speaker may also be positioned within the passenger loading apparatus.

Further, the present invention also includes a display system adapted to be placed along a passenger loading apparatus. The display system includes at least two displays corresponding to a common theme that are adapted to be displayed on at least two interior surfaces of a passenger loading apparatus. Each of the at least two displays may be selected from the group consisting of a panel, sticker, LCD screen, a television monitor, wall pocket, and combinations thereof. Further, the at least two surfaces may include a ceiling and wall and the at least at least two displays may cover at least a portion of the ceiling and wall of the passenger loading apparatus. The at least two displays may substantially cover the entire surface of the at least two interior surfaces of the passenger loading apparatus.

The present invention may also includes a passenger loading apparatus that includes a passenger loading apparatus having a surface visible to a passenger passing therethrough and a display on the surface. The display may be selected from the group consisting of a panel, sticker, LCD screen, a television monitor, wall pocket and combinations thereof. Further, the passenger loading apparatus may include a plurality of displays. The plurality of displays may coordinate to form a common theme.

### BRIEF DESCRIPTION OF THE DRAWINGS

FIG. 1 illustrates a passenger loading apparatus extending from an airport terminal and has a plurality of displays contained on the vertical walls of the passenger loading apparatus in accordance with one embodiment of the present invention;

FIG. 2 illustrates a passenger loading apparatus extending from an airport terminal and has a plurality of displays contained on the floor and ceiling of the passenger loading apparatus in accordance with one embodiment of the present invention;

FIG. 3 illustrates a passenger loading apparatus extending from an airport terminal where the displays are on the interior walls, ceiling, and floor and forms a continuous theme through the passenger loading apparatus in accordance with one embodiment of the present invention;

FIG. 4 illustrates a passenger loading apparatus having a fixed portion and an extended portion with displays on the fixed portion and extended portion in accordance with one embodiment of the present invention; and

FIG. 5 shows a variety of displays contained in a passenger loading apparatus in accordance with one embodiment of the present invention.

### DETAILED DESCRIPTION OF THE INVENTION

The present invention is directed to a display system or an advertising system adapted to be placed in a passenger loading apparatus. The display is visible and accessible to a passenger as the passenger travels through the passenger loading apparatus. The passenger loading apparatus is typically a confined space that passengers must pass through in order to get to the desired transportation device, such as an airplane. This leads to a captured audience of passengers, and provides a unique opportunity to provide a message to the passengers either loading onto or unloading from the transportation device. The messages could be advertisements, safety messages, or the like.

As used herein, “passenger loading apparatus” is an apparatus used to load passengers in a transportation device such as an airplane, train, ship, and the like. The passenger loading apparatus may be an enclosure containing interior surfaces that are exposed or in plain view to a passenger passing therethrough. These interior surfaces typically include a floor, ceiling, and sidewalls that extend to the transportation device. Alternatively, the passenger loading apparatus may be an open enclosure. An example of an open enclosure would be a passenger loading apparatus without a ceiling or sidewall. The passenger loading apparatus may be a fixed length or may be adjustable as in the case of an airport passenger loading apparatus. An adjustable passenger loading apparatus typically has a fixed portion attached to a terminal and an extending portion that extends to reach a transportation device, such as an airplane.

The display of the present invention may be a graphic or textual message or a combination of text and graphics affixed to the passenger loading apparatus. In a preferred embodiment, the display is affixed to an interior surface of the passenger loading apparatus that is visually available to the passenger. The display may take on a variety of forms. For example, the display may be a panel or made from a sticker material. One suitable sticker material is Scotchcut™ Film 220-10 manufactured by 3M. This particular sticker material has flame retardant properties that meet the requirements for NFPA Rational Fire Protection Association) Class A(1). Also, a light box may be used to illuminate a panel, sticker or other display. Other types of displays may include an LCD panel and a television type monitor. Still further, the display may include a multi-directional display that displays different messages on the same display depending upon the direction that the passenger is moving. For example, one message on the display is visible to a passenger moving towards the transportation device and another message is visible to a passenger moving away from the transportation device. The multi-directional displays are particularly useful to maximize the surface area in the passenger loading apparatus. The display may also be a wall pocket designed to hold literature, product samples or the like.

Any of the displays may be used in combination with one another to enhance the message to the passenger. Speakers may also be used alone or in combination with one or more displays. Likewise, scents may be used in combination with displays to further enhance the message to the passenger. Furthermore, a series of displays in combination with speakers and scents may be used to provide a particular theme to the passenger.

The size and shape of a display is not limited except by the size of the passenger loading apparatus and its operation. The number of displays is limited only by the size of the passenger loading apparatus. Further, the configuration and location of the displays is not limited except that the displays should be configured so as not to interfere with the operation of the passenger loading apparatus.

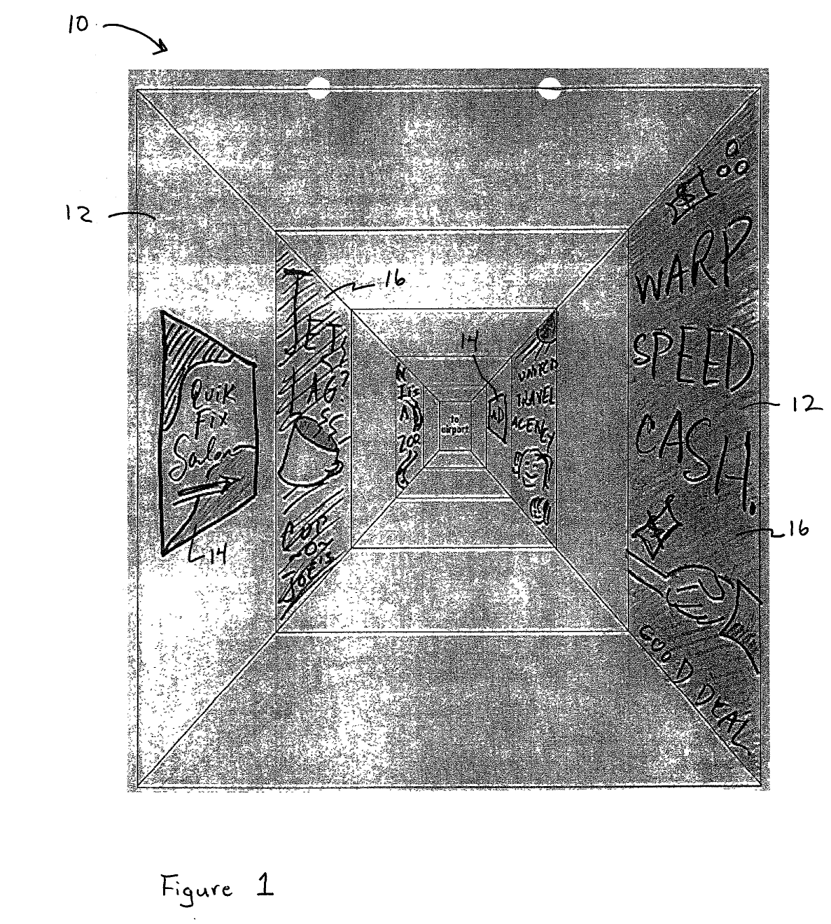

With reference now to FIG. 1, there is shown a passenger loading apparatus 10 extending from an airport terminal with displays 14 and full-length displays 16 in accordance with one embodiment of the present invention. The interior walls 12 of the passenger loading apparatus 10 may have a plurality of displays 14 located on a portion of the interior walls 12. Full-length displays 16 extend from the floor to the ceiling of the passenger loading apparatus 10. In one embodiment, the displays 14 and the full-length displays 16 may be sticker material affixed to the walls 12 by an adhesive or a panel attached to the walls of the passenger loading apparatus. In FIG. 1, each of the displays 14 and full-length displays 16 have different graphical and textual messages.

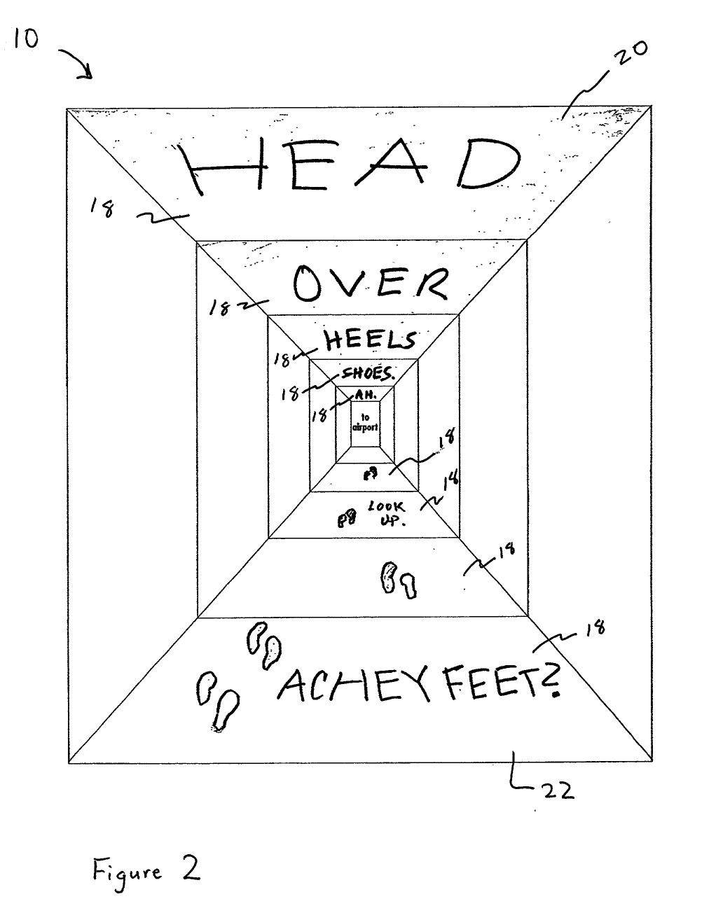

FIG. 2 illustrates another embodiment of the present invention. A passenger loading apparatus 10 extends from an airport terminal and contains a plurality of complementary displays 18 arranged on the ceiling 20 and floor 22 of the passenger loading apparatus 10. The complimentary displays 18 provide a common message or theme to the passenger. For example, by looking at the displays 18 on the floor 22 refer the passenger to observe the displays on the ceiling 20. In FIG. 2, the common message is for shoes, however, any common message or a combination of messages could be utilized.

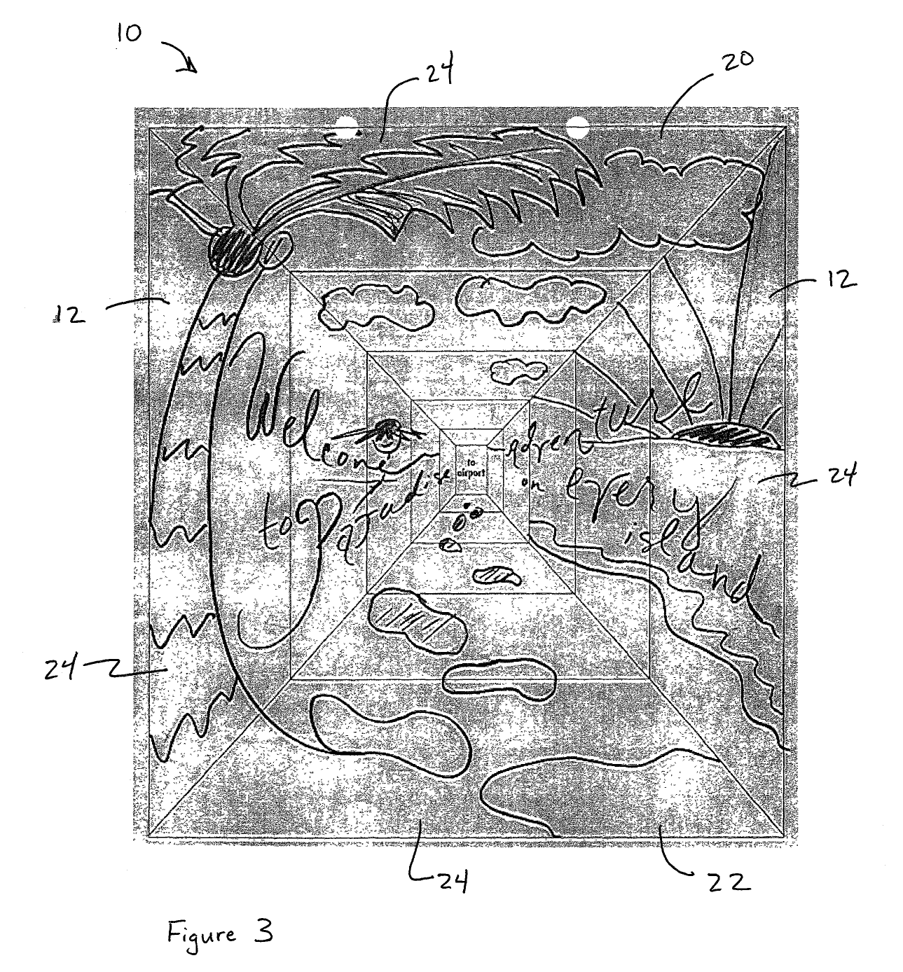

Turning now to FIG. 3, there is shown another embodiment of the present invention. FIG. 3 illustrates a passenger loading apparatus 10 extending from an airport terminal where a plurality of displays 24 on the ceiling 20, walls 12, and floor 22 form a common theme or image. There may be one display on each interior surface or there may be one display that spans more than one interior surface. In this way, a passenger passing through the passenger loading apparatus is immersed in a desired theme. The theme could be for a particular attraction such as a theme park, sports team, company, and the like. The displays do not have to be flat displays lining the walls, but they could contain a three-dimensional component extending from the surfaces of the passenger loading apparatus. This aspect is particularly useful with a theme to further enhance the effect on the passenger.

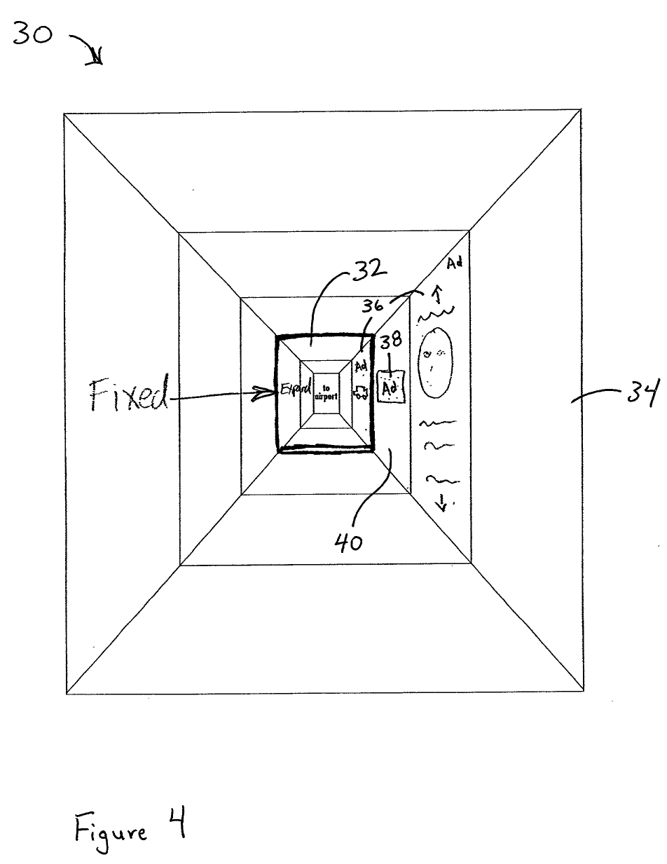

FIG. 4 shows an adjustable passenger loading apparatus 30 having a fixed portion 32 and an adjustable portion 34. Displays 36 may be located on the fixed portion 32 and the adjustable portion 34. Additional displays 38 may be located on an extension portion 40 such that as the passenger loading apparatus 30 is adjusted, the additional display 38 is revealed. The additional display 38 may be a distinct display or may be a continuation of one or more displays 36.

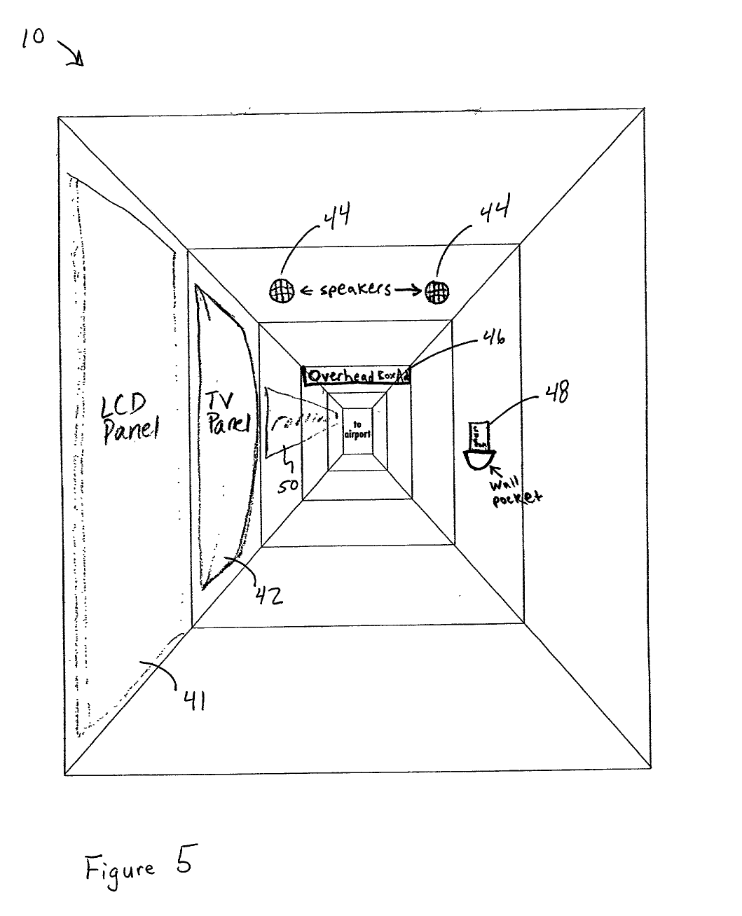

Another embodiment of the present invention is illustrated in FIG. 5 where a variety of displays are located on the interior surfaces of a passenger loading apparatus 10. An LCD panel 41 may be position on the wall 12. The LCD panel 41 may be used to provide a variety of different messages using the same space on the wall. A television type monitor 42 may be positioned in the passenger loading apparatus 10 and may be used to provide a variety of messages to the passenger. One or more peakers 44 may be combined with the television monitor 42 to provide an audio and visual message to the passenger. Speakers may be combined with any of the displays to enhance the message to the passenger. Where the displays in the passenger loading apparatus form a theme, the speaker may be used to enhance the theme. For example, jungle noises could be played in a jungle theme. FIG. 5 also shows an overhead display 46 extending from the ceiling 20 and a wall pocket 48 that can be used to distribute literature, samples, or the like. The overhead display 46 may be two-sided with a different message on each side of the display. Additionally one display 50 may be used to span one or more panels or surfaces of the passenger loading apparatus.

It will be readily understood by those persons skilled in the art that the present invention is susceptible to broad utility and application. Many embodiments and adaptations of the present invention other than those herein described, as well as many variations, modifications and equivalent arrangement, will be apparent from or reasonably suggested by the present invention and the foregoing description without departing from the substance or scope of the present invention.

Accordingly, while the present invention has been described in detail in relation to its preferred embodiment, it is to be understood that this disclosure is only illustrative and exemplary of the present invention and is made merely for purposes of providing a full and enabling disclosure of the invention. The foregoing disclosure is not intended to be construed to limit the present invention or otherwise exclude any other embodiments, adaptations, variations, modifications or equivalent arrangements, the present invention being limited only by the claims and the equivalents thereof.

What is claimed is:

1. An advertisement system adapted to be placed along a passenger loading apparatus, the advertisement system comprising at least one display adapted to be displayed on at least one interior surface of the passenger loading apparatus such that the display is in view of a passenger passing therethrough.

2. The advertisement system of claim 1 wherein said at least one display is selected from the group consisting of a panel, sticker, LCD screen, a television monitor, wall pocket, and combinations thereof.

3. The advertisement system of claim 1 further comprising a plurality of displays.

4. The advertisement system of claim 1 wherein said at least one display is on at least two surfaces of the passenger loading apparatus.

5. The advertisement system of claim 4 wherein said at least two surfaces includes a ceiling and wall and wherein said at least one display covers at least a portion of the ceiling and wall of the passenger loading apparatus.

6. The advertisement system of claim 1 further comprising a speaker positioned within the passenger loading apparatus.

7. A display system adapted to be placed along a passenger loading apparatus, the display system comprising at least two displays corresponding to a common theme adapted to be displayed on at least two interior surfaces of a passenger loading apparatus.

8. The display system of claim 7 wherein each of said at least two displays is selected from the group consisting of a panel, sticker, LCD screen, a television monitor, wall pocket, and combinations thereof.

9. The display system of claim 7 wherein said at least two surfaces includes a ceiling and wall and wherein said at least at least two displays covers at least a portion of the ceiling and wall of the passenger loading apparatus.

10. The display system of claim 7 wherein said at least two displays substantially cover the entire surface of said at least two interior surfaces of the passenger loading apparatus.

11. A passenger loading apparatus comprising:
a passenger loading apparatus having a surface of a wall visible to a passenger passing therethrough; and
a display affixed to the surface of the wall, wherein said display is visible to a passenger passing therethrough.

12. The passenger loading apparatus of claim 11 wherein said display is selected from the group consisting of a panel, sticker, LCD screen, a television monitor, wall pocket, and combinations thereof.

13. The passenger loading apparatus of claim 11 wherein said display is a sticker and said surface includes a wall and wherein said display sticker substantially covers the wall.

14. The passenger loading apparatus of claim 11 wherein said passenger loading apparatus includes a ceiling, floor, and walls, and wherein said passenger loading apparatus further comprises plurality of display stickers positioned on said walls.

15. The passenger loading apparatus of claim 13 wherein said plurality of display stickers combine to form a common theme.
